(19) United States
(12) Patent Application Publication
(10) Pub. No.: US 2026/0246750 A1
(43) Pub. Date: Aug. 20, 2026

(54) METHOD, APPARATUS, DEVICE, STORAGE MEDIUM AND PROGRAM PRODUCT FOR MESSAGE ALLOCATION

(71) Applicant: Bytedance Technology Ltd., Grand Cayman (KY)

(72) Inventors: Baojun HU, Beijing (CN); Jian TIAN, Culver City, CA (US); Zishen QU, Beijing (CN)

(21) Appl. No.: 19/170,112

(22) Filed: Apr. 4, 2025

(30) Foreign Application Priority Data
Feb. 20, 2025 (CN) 202510191755.2

(51) Int. Cl. H04L 51/21

(52) U.S. Cl. CPC H04L 51/21

(57) ABSTRACT

According to embodiments of the disclosure, methods, apparatuses, devices, storage media and program products for message allocation are provided. An example method includes: obtaining respective verification pass rates of a plurality of message channels and respective unit costs of message transmissions of the plurality of message channels; determining, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and allocating verification code messages to the plurality of message channels based on the respective message allocation weights of the plurality of message channels, wherein a verification code message is sent via the allocated message channel.

### CROSS-REFERENCE

This application claims priority to Chinese Application No. 202510191755.2, filed on Feb. 20, 2025 and entitled ‘METHOD, APPARATUS, DEVICE, STORAGE MEDIUM AND PROGRAM PRODUCT FOR MESSAGE ALLOCATION’, which is incorporated herein by reference in its entirety.

### FIELD

Example embodiments of the present disclosure generally relate to the field of computers, and in particular, to a method, apparatus, electronic device, computer-readable storage medium and computer program product for message allocation.

### BACKGROUND

With the rapid development of Internet technologies, the message service for verification code messages has become an indispensable part of many online services. Message service plays an important role in aspects of user verification, information notification, safety reminding, and the like. The message allocation system may send a verification code message to a user in a user group via at least one message channel. The user may perform a corresponding verification operation on a corresponding client device based on the received verification code message.

### SUMMARY

In a first aspect of the present disclosure, a method for message allocation is provided. The method includes: obtaining respective verification pass rates of a plurality of message channels and respective unit costs of message transmissions of the plurality of message channels; determining, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and allocating verification code messages to the plurality of message channels based on the respective message allocation weights of the plurality of message channels, wherein a verification code message is sent via the allocated message channel.

In a second aspect of the present disclosure, an apparatus for message allocation is provided. The apparatus includes: an obtaining module configured to obtain respective verification pass rates of a plurality of message channels and respective unit costs of message transmissions of the plurality of message channels; a weight determining module configured to determine, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and a message allocating module configured to allocate verification code messages to the plurality of message channels based on the respective message allocation weights of the plurality of message channels, wherein a verification code message is sent via the allocated message channel.

In a third aspect of the present disclosure, an electronic device is provided. The device includes at least one processing unit; and at least one memory coupled to the at least one processor and storing instructions for execution by the at least one processor, the instructions, when executed by the at least one processor, causing the electronic device to perform the method of the first aspect.

In a fourth aspect of the present disclosure, a computer-readable storage medium is provided. The medium has computer-executable instructions stored thereon, the computer-executable instructions being executable by a processor to implement the method of the first aspect.

In a fifth aspect of the present disclosure, a computer program product is provided. The product includes computer executable instructions, wherein the computer-executable instructions, when executed by a processor, implement the method of the first aspect of the present disclosure.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure may be implemented;

FIG. 2A illustrates a schematic diagram of an example for message allocation according to some embodiments of the present disclosure;

FIG. 2B illustrates a schematic diagram of a convex optimization algorithm according to some embodiments of the present disclosure;

FIG. 2C illustrates a schematic diagram of an example process of determining a verification pass rate according to some embodiments of the present disclosure;

FIG. 2D illustrates a schematic diagram of an example process of determining a message allocation weight according to some embodiments of the present disclosure;

FIG. 3 illustrates a flowchart of a method for message allocation according to some embodiments of the present disclosure;

FIG. 4 illustrates a schematic structural block diagram of an apparatus for message allocation according to some embodiments of the present disclosure; and

FIG. 5 illustrates a block diagram of an electronic device in which one or more embodiments of the present disclosure may be implemented.

### DETAILED DESCRIPTION

Embodiments of the present disclosure will be described in more details below with reference to the accompanying drawings. While certain embodiments of the present disclosure are shown in the accompanying drawings, it would be appreciated that the present disclosure may be implemented in various forms, and would not be construed as limited to the embodiments set forth herein, but rather, these embodiments are provided for a more thorough and complete understanding of the present disclosure. It would be appreciated that the drawings and embodiments of the present disclosure are for example purposes only and are not intended to limit the scope of the present disclosure.

In the description of the embodiments of the present disclosure, the terms “including”, and the like would be appreciated to include “including but not limited to”. The term “based on” would be appreciated as “based at least in part on”. The terms “one embodiment” or “the embodiment” would be appreciated as “at least one embodiment”. The term “some embodiments” would be appreciated as “at least some embodiments”. Other explicit and implicit definitions may also be included below.

Herein, unless explicitly stated, “in response to A” performs one step and does not imply that this step is performed immediately after “A” but may include one or more intermediate steps.

It may be appreciated that the data involved in the technical solution (including but not limited to the data itself, the obtaining, using, storing, or deleting of the data) would follow the requirements of the corresponding laws and regulations and related regulations.

It may be appreciated that before using the technical solutions disclosed in the embodiments of the present disclosure, relevant users would be informed of the types, usage ranges, usage scenarios, and the like of the information related to the present disclosure in an appropriate manner according to relevant laws and regulations, and the authorization of the related users may be obtained, wherein the relevant users may include any type of rights body, such as individuals, businesses, and groups.

For example, in response to receiving an active request of a user, prompt information is sent to the related user to explicitly prompt the related user, and the operation requested to be performed will need to obtain and use the information of the related user, so that the related user may autonomously select whether to provide information to software or hardware executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “disagree” to provide information to the electronic device.

It may be appreciated that the foregoing notification and obtaining a user authorization process are merely illustrative, and do not constitute a limitation on implementations of the present disclosure, and other manners of satisfying related laws and regulations may also be applied to implementations of the present disclosure.

As mentioned previously, the message allocation system may send a verification code message to a user in a group of users via at least one message channel. Where a plurality of message channels are included, in some conventional scenarios, a message channel for sending a verification code message is typically determined randomly from a plurality of message channels or based on relevant settings. In some other conventional scenarios, a respective message transmission success rate of the plurality of message channels may be determined based on respective historical message transmission situation of the plurality of message channels, and respective message allocation weights of the plurality of message channels may be determined based on respective message transmission success rates of the plurality of message channels. The verification code messages may be allocated to the plurality of message channels based on their respective message allocation weights. It may be appreciated that the number of the verification code messages sent by the message channel of the message allocation weight becomes larger. The conventional message allocation method of the random selection message channel, the message allocation method based on the setting to select the message channel and the message allocation method based on the message transmission success rate to select the message channel may not ensure that the total cost of sending the message by using the plurality of message channels satisfies the expectation of the user, and it is expected that how to use the plurality of message channels to send the message may be determined based on the total cost.

In view of this, according to an embodiment of the present disclosure, an improved solution for message allocation is provided. According to the scheme of the embodiment of the invention, the verification pass rate of each message channel and the unit cost of message transmission of each message channel are obtained. A message allocation weight of each of the plurality of message channels is determined based at least on respective verification pass rates and the respective unit costs of the plurality of message channels, the message allocation objectives being associated with at least a total cost of message transmissions of the plurality of message channels. A verification code message is allocated to the plurality of message channels based on respective message allocation weights of the plurality of message channels, wherein the verification code message is sent via the allocated message channel.

In this manner, the respective message allocation weights of the plurality of message channels are determined based on the respective verification pass rates of a plurality of message channels, the respective unit costs of message transmissions of the plurality of message channels, and the message allocation objective associated with the total cost of the message transmission, and the verification code messages are allocated to the plurality of message channels based on their respective message allocation weights. Such a message allocation policy may ensure that the total cost sent with the message satisfies the message allocation objective, which helps reduce the cost of message transmission.

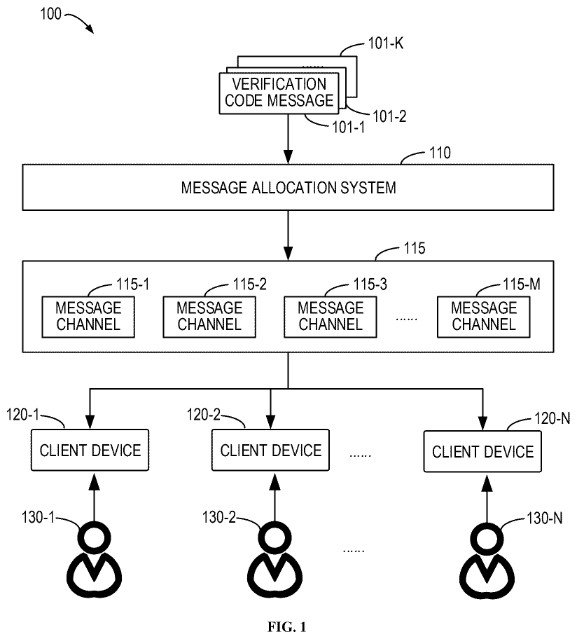

FIG. 1 illustrates a schematic diagram of an example the environment 100 in which embodiments of the present disclosure may be implemented. In the environment 100, a message allocation system 110 may send at least one verification code message 101 to at least one client device 120 corresponding to at least one user 130 via a plurality of message channels 115. The plurality of message channels 115 may include message channels 115-1, 115-2, 115-3, . . . , 115-M (collectively or separately referred to as the message channel 115), wherein M is a positive integer greater than 1. The plurality of message channels may, for example, correspond to different messaging agents, or different messaging plans, etc., to distinguish the channels of the message transmission path.

The at least one verification code message 101 may include a verification code message 101-1, 101-2, . . . , 101-K (collectively or separately referred to as verification code message 101), wherein K is a positive integer. The verification code message may include a short message, an instant messaging message, or a wait. At least one user 130 may include users 130-1, 130-2, . . . , 130-N (collectively or individually as the user 130), at least one client device 120 corresponding to at least one user 130 may include client devices 120-1, 120-2, . . . , 120-N (collectively or individually as the client device 120), wherein N is a positive integer.

After receiving the verification code message 101, the user 130 may perform an operation associated with the verification code message via the client device 120. For example, if the user 130 desires to log in a certain application, the client device 120 may provide a verification code login interface, and the user 130 may input the verification code in the received verification code message into the login entrance in the verification code login interface. In the case that the verification code input by the user 130 is correct, the user 130 may log in to a corresponding application.

The message allocation system 110 may be implemented in various types of computing systems/service devices capable of providing computing power. The server device may be an independent physical server, or may be a server cluster or an allocated system composed of a plurality of physical servers, or may be a cloud server that provides basic cloud computing services such as cloud services, cloud databases, cloud computing, cloud functions, cloud storage, network services, cloud communications, middleware services, domain name services, security services, content allocation networks, and big data and artificial intelligence platforms. The server device may include, for example, a computing system/server, such as a mainframe, an edge computing node, a computing device in a cloud environment, or the like.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

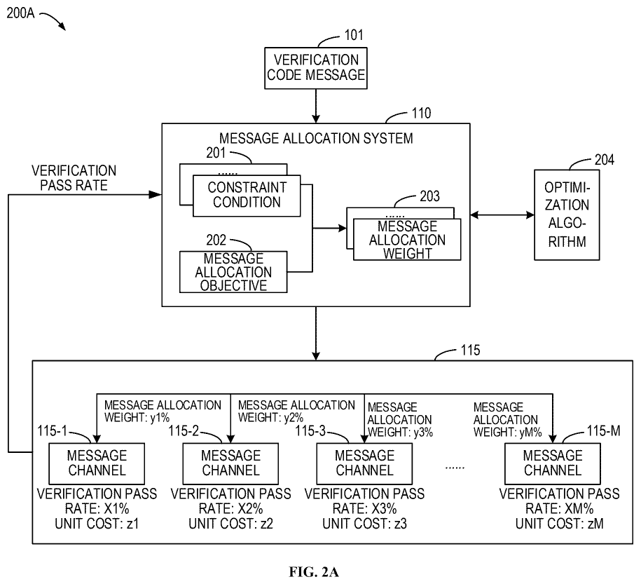

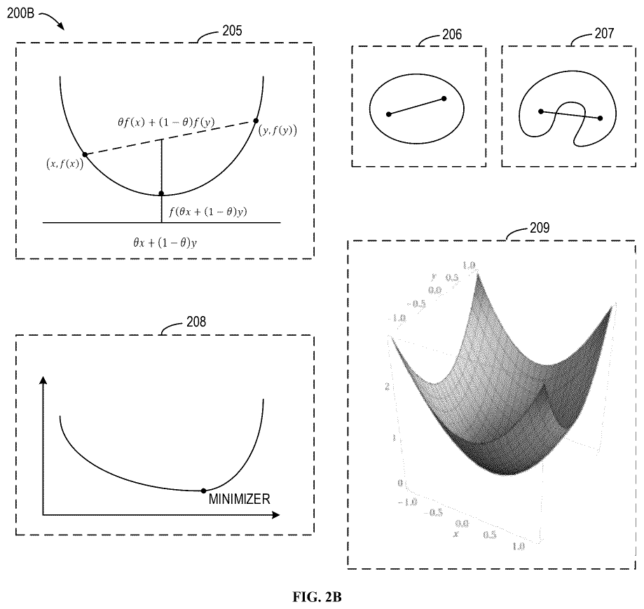

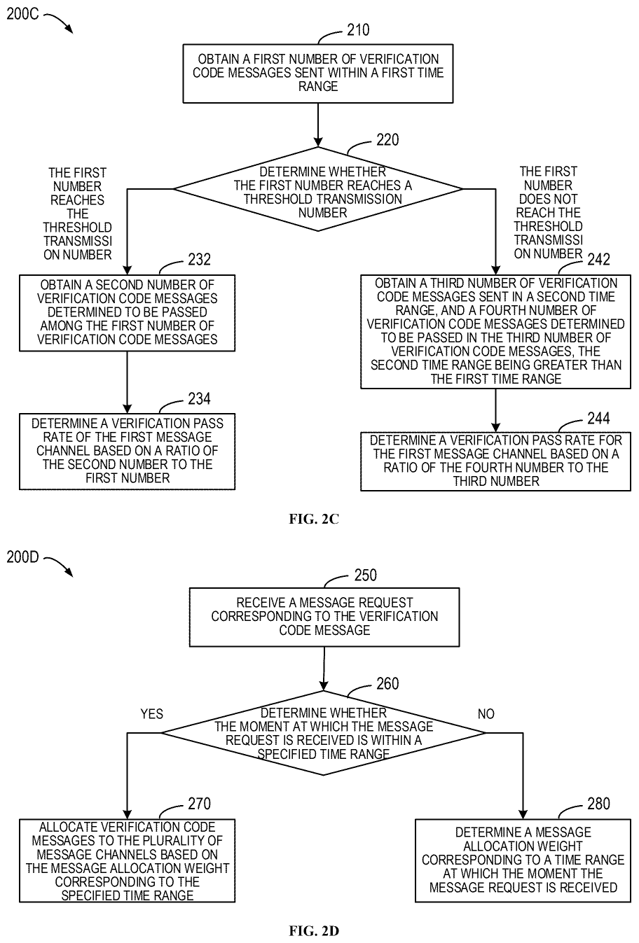

FIG. 2A illustrates a schematic diagram of an example 200A for message allocation according to some embodiments of the present disclosure. The example 200A may be implemented at the message allocation system 110.

The message allocation system 110 may obtain respective verification pass rates of the plurality of message channels 115 and respective unit costs of message transmissions of the plurality of message channels. For example, the message allocation system 110 may obtain the verification pass rate X1% and the unit cost z1 of the message channel 115-1, the verification pass rate X2% and the unit cost z2 of the message channel 115-2, the verification pass rate X3% and the unit cost z3 of the message channel 115-3, . . . , the verification pass rate XM % and the unit cost zM of the message channel 115-M. The unit cost of each message channel 115 may be predetermined or may vary with the condition of the message channel. For example, the message allocation system 110 may store the respective unit costs of the plurality of message channels 115 input by the user in advance, and the message allocation system 110 may directly obtain the respective unit costs of the plurality of message channels from the system locally. If the unit cost corresponding to the message channel changes, the updated unit cost may also be updated to the message allocation system 110.

The verification pass rate of the message channel is sometimes also referred to as a verification code rate of the message channel, and is for indicating whether the verification code message sent through the message channel may be finally successfully used for verification. The verification pass rate is able to indicate a degree of reliability of sending the verification code message through the message channel. In some embodiments, the verification pass rate of the message channel may be determined based on a number of verification code messages sent by the message channel in a certain time range, and a number of verification code messages determined to be passed in the sent verification code messages, for example, may be determined based on a ratio of the number of the sent verification code messages to the number of verification code messages determined to be passed. For example, the message allocation system 110 may determine the verification pass rate of the message channel A based on a ratio of the number A of verification code messages sent by a message channel A in 30 minutes to the number B of verification code messages determined to be passed in the verification code message of the number A, which may be, for example, A/B. The respective verification pass rates of the plurality of message channels 115 may be determined in real time by the message allocation system 110, or may be periodically determined by the message allocation system 110 (e.g., once every hour).

The message allocation system 110 may determine respective message allocation weights 203 of the plurality of message channels 115 according to a message allocation objective 202 based at least on respective verification pass rates and the respective unit costs of the plurality of message channels 115. The message allocation objective 202 may be associated with at least the total cost of the message transmissions of the plurality of message channels 115. In some embodiments, the message allocation objective 202 may be configured to minimize or decrease the total cost of the message transmissions of the plurality of message channels 115 to satisfy a first target value. Under such message allocation objectives, it is desirable to achieve the goal of minimizing cost or satisfying cost goals by adjusting the message allocation weights 203 of the plurality of message channels 115.

The total cost of message transmissions of the plurality of message channels 115 may be determined based on the respective message allocation weights 203 and respective unit costs of the plurality of message channels 115. Referring to FIG. 2A, if the message allocation weight of the message channel 115-1 is y1%, the unit cost is z1, the message allocation weight of the message channel 115-2 is y2%, the unit cost is z2, the message allocation weight of the message channel 115-3 is y3%, the unit cost is z3, . . . , the message allocation weight of the message channel 115-M is yM % and the unit cost is zM, then the total cost of message transmissions for the plurality of message channels 115 is y1%*z1+y2%*z2+y3%*z3+ . . . yM %*zM.

The first target value may be a value specified by the user or determined by the message allocation system 110 in any suitable manner. Thus, the message allocation system 110 allocates the verification code messages 101 to the plurality of message channels 115 based on the determined message allocation weights 203 to ensure that the total cost of sending the verification code messages 101 using the plurality of message channels 115 is the lowest.

In some embodiments, the message allocation objective 202 may be configured to maximize or increase a ratio of an average verification pass rate of the message transmissions of the plurality of message channels 115 to the total cost to satisfy a second target value. Because a high verification pass rate is one of the expectations in the verification code message transmission scenario. Therefore, by adjusting the message allocation weights 203 of the plurality of message channels 115, the ratio of an average verification pass rate to the total cost is maximized or increased, thereby implementing a high cost performance in the verification code transmission scenario. In this specification, the average verification pass rate is determined based on the respective message allocation weights 203 and verification pass rates of the plurality of message channels 115, for example, may be determined as a weighted average of the verification pass rates of the plurality of message channels. Referring to FIG. 2A, if the message allocation weight of the message channel 115-1 is y1%, the verification pass rate is X1%, the message allocation weight of the message channel 115-2 is y2%, the verification pass rate is X2%, the message allocation weight of the message channel 115-3 is y3%, the verification pass rate is X3%, . . . , the message allocation weight of the message channel 115-M is yM %, and the verification pass rate is XM %, the average verification pass rate of the message transmissions of the plurality of message channels 115 may be determined based on: y1%*X1%+y2%*X2%+y3%*X3%+ . . . +yM %*XM %.

The ratio of the average verification pass rate to the total cost may indicate the cost performance of sending the verification code messages 101 using the plurality of message channels 115. The second target value may also be a value specified by the user or determined by the message allocation system 110 in any suitable manner. Thus, the message allocation system 110 allocates the verification code messages 101 to the plurality of message channels 115 based on the determined message allocation weights 203 to ensure that the cost performance of sending the verification code messages 101 using the plurality of message channels 115 is high.

In some embodiments, the message allocation objective 202 may be represented as an objective function associated with at least the respective message allocation weights 203 of the plurality of message channels 115. In some examples, if the message allocation objective 202 is configured to minimize or decrease the total cost of message transmissions of the plurality of message channels 115 to satisfy the first target value, the message allocation objective 202 may be represented as an objective function shown below:

$$f ( w ) = max \frac{{\sum }_{i = 1}^{M} ( {w}_{i} \times c {r}_{i}^{a} )}{{\sum }_{i = 1}^{M} ( {w}_{i} \times p {r}_{i}^{b} )} \qquad ( 1 )$$

In some examples, if the message allocation objective 202 is configured to maximize or increase a ratio of an average verification pass rate of the message transmissions of the plurality of message channels 115 to the total cost to satisfy a second target value, the message allocation objective 202 may be represented as an objective function shown below:

$$f ( w ) = \begin{matrix}min \\ w\end{matrix} {\sum }_{i = 1}^{M} ( {w}_{i} \times p {r}_{i} ) \qquad ( 2 )$$

In the foregoing formulas (1) and (2), crᵢ is used to represent a verification pass rate of the ith message channel, prᵢ is used to represent a unit cost of message transmission of the ith message channel, wᵢ is used to represent a message allocation weight of the ith message channel, and a and b are two hyperparameters.

The message allocation system 110 may determine, based on at least the respective verification pass rates and the respective unit costs of the plurality of message channels 115, the respective message allocation weights 204 of the plurality of message channels 115 by solving the objective function with a convex optimization algorithm 204. The optimization algorithm 204 may include any suitable optimization algorithm such as a convex optimization algorithm, a gradient descent method, a simulated annealing method, or a Newton method. In some embodiments, the message allocation system 110 may determine, based on at least the respective verification pass rates and the respective unit costs of the plurality of message channels 115, the respective message allocation weights 204 of the plurality of message channels 115 by solving the objective function with a convex optimization algorithm.

Referring to FIG. 2B, FIG. 2B illustrates a schematic diagram 200B of a convex optimization algorithm according to some embodiments of the present disclosure. In FIG. 2B, block 205 illustrates an optimal finding logic for the convex optimization algorithm, for any two points x and y, and any 0≤θ≤1, convex function ƒ satisfies the following inequality:

$$f ( θ x + ( 1 - θ ) y ) \leq θ f ( x ) + ( 1 - θ ) f ( y ) \qquad ( 3 )$$

Function values ƒ(x) and ƒ(y) of the function ƒ at points x and y are shown in block 205. At block 205, a new point θx+(1−θ)y is constructed by the parameter θ that lies on the curve line segment between x and y. Block 205 may represent that the function value of the convex function on the curve line segment between any two points does not exceed the weighted average of the two point function values.

The ellipse in block 206 represents a convex set, the irregular shape in block 207 represents a non-convex set, and block 206 and block 207 represents a feature of convex optimization: a line segment between any two points in the convex set is completely located in the set. The two-dimensional graph in block 208 illustrates a convex function, represented as a U-curve. Block 208 illustrates a feature of convex optimization: the line segment between any two points in the convex function is above or coincides with the function image. The minimizer of the function is the global minimum of the function. The three-dimensional graph in block 209 illustrates a three-dimensional convex function, represented as a bowl-shaped curved surface. The convex function also has similar properties in higher dimensions, i.e., the function is “convex up” throughout the definition domain.

Therefore, by adopting the convex optimization algorithm, channel selection may be performed on the premise of ensuring the verification pass rate of the channel, and the channel allocation scheme of the message allocation objective may be satisfied. The convex optimization algorithm has a better effect in finding an extreme target value, and any local minimum value is a global minimum value. This means that the solution found by the algorithm must be globally optimal without worrying about getting stuck in a local minimum. This may ensure that the determined message allocation weight may be most likely to satisfy the message allocation objective.

In some embodiments, in order to ensure that the better quality of the respective message allocation weights 203 of the determined plurality of message channels 115, the message allocation system 110 may further obtain at least one constraint condition 201, and determine, in response to at least one constraint condition 201 being satisfied, the respective message allocation weights 203 of the plurality of message channels 115 according to the message allocation objective 202. In some embodiments, the at least one constraint condition 201 may be determined based on at least one of the following: the respective verification pass rates of the plurality of message channels 115, or the respective unit costs of the plurality of message channels 115. For example, the at least one constraint condition 201 may include a constraint A and a constraint B, the constraint A may indicate that the respective verification pass rates of the plurality of message channels 115 is within a certain numerical range, and the constraint B may indicate that a total cost of the plurality of message channels 115 is within a certain numerical range. In some embodiments, when the objective function is used to solve the message allocation weights of the plurality of message channels 115, the determination of the solution result further satisfies at least one constraint condition.

In some embodiments, the at least one constraint 201 may include a first constraint that may indicate that a message allocation weight for each message channel 115 is within a specified range. The specified range may be represented as a range (minRatio, maxRatio), wherein minRatio is a lower limit of the range, which indicates a minimum tolerance value of the message allocation weight, maxRatio is an upper limit value of the range, and indicates a maximum value of the message allocation weight. The lower limit value and the upper limit value herein may be configured as appropriate values as needed. The first constraint may be represented as: minRatio<wᵢ<maxRatio. Through the first constraint condition, it may be avoided that the message allocation weight of a single message channel is determined to be too large or too small beyond the tolerance limit during the weight determination process.

In some embodiments, the at least one constraint 201 may include a second constraint that may indicate that a total message allocation weight of the plurality of message channels 115 satisfies a predetermined value. The predetermined value may be any suitable value. Generally, the predetermined value may be 1, for example, the total message allocation weight of the plurality of message channels 115 is 1. The second constraint may be represented as

$${\sum }_{i = 1}^{M} {w}_{i} = 1 .$$

In some embodiments, the at least one constraint 201 may include a third constraint that may indicate that an average verification pass rate of the plurality of message channels 115 reaches a threshold verification pass rate. For example, minTotalCr may be used to identify the threshold verification pass rate, which may also be any suitable value. Through the third constraint condition, the average verification pass rate of the plurality of message channels after the message allocation weight is determined may be constrained to satisfy a minimum requirement, that is, minTotalCr. The third constraint may be represented as

$${\sum }_{i = 1}^{M} ( {w}_{i} \times {cr}_{i} ) \geq minTotalCr .$$

In some embodiments, the at least one constraint 201 may include a fourth constraint that may indicate that the total cost of the message transmissions of the plurality of message channels 115 is lower than a threshold cost. For example, the threshold cost may be identified by max TalPr, which may likewise be any suitable value. Through the fourth constraint condition, the total cost of the plurality of message channels after the message allocation weight is determined may not exceed the upper limit. The fourth constraint may be represented as

$${\sum }_{i = 1}^{M} ( {w}_{i} \times p {r}_{i} ) \geq maxTotalPr .$$

In some embodiments, the message allocation system 110 may determine the respective message allocation weights 203 of the plurality of message channels 115, for example, by using a machine learning model of the optimization algorithm 204. The message allocation system 110 may determine a model input for the machine learning model based on the at least one constraint 201, the message allocation objective 202 (e.g., which may be an objective function, for example), the respective verification pass rates and the respective unit costs of the plurality of message channels 115. It would be noted that, taking the at least one constraint condition 201 including the foregoing first constraint condition to the fourth constraint condition as an example, the message allocation system 110 further needs to determine a model input based on several specific values of minRatio, maxRatio, a predetermined value (for example, 1), minTotalCr, and maxTalPr. The message allocation system 110 may provide the model input to the machine learning model and obtain a model output of the machine learning model output for the model input. The message allocation system 110 may determine the respective message allocation weights 203 of the plurality of message channels 115 based on the model output.

The message allocation system 110, in turn, may allocate verification code messages to the plurality of message channels 115 based on the determined respective message allocation weights 203 of the plurality of message channels 115, wherein the verification code messages are sent via the allocated message channels. In some embodiments, the message allocation system 110 may allocate verification code messages to the plurality of message channels 115 in sequence based on their respective message allocation weights 203. For example, if the plurality of message channels 115 include 3 message channels of the message channel A, the message channel B and the message channel C, and the message allocation weights of the 3 message channels are 0.3, 0.4, and 0.3 in sequence, and there are 5 verification code messages to be sent, the message allocation system 110 may first allocate 3 verification code messages to the message channel A, and then allocate the remaining 2 verification code messages to the message channel B, so that the 5 verification code messages are sent.

In some embodiments, the message allocation system 110 may randomly allocate verification code messages to the plurality of message channels 115 based on their respective message allocation weights 203. In this case, for the verification code message to be allocated, the message allocation system 110 may randomly determine the message channels for sending the verification code message from the plurality of message channels 115, and the message allocation system 110 only needs to ensure that the message transmission condition of the plurality of message channels 115 satisfies the message allocation weights 203 of the plurality of message channels 115. For example, if the plurality of message channels 115 include 3 message channels of the message channel A, the message channel B and the message channel C, the message allocation weights of the four message channels are 0.3, 0.4, and 0.3 in sequence, for each verification code message, the message allocation system 110 may randomly determine the message channel for sending the verification code message from the 3 message channels, and the message allocation system 110 only needs to ensure that the ratio of the number of the verification code messages sent by the last 3 message channels is 3:4:3.

Thus, the message allocation system 110 may determine the respective message allocation weights of the plurality of message channels based on the respective verification pass rates of the plurality of message channels, the respective unit costs for message transmissions of the plurality of message channels, and the message allocation objectives associated with the total cost of the message transmission, and allocate verification code messages to the plurality of message channels based on the respective message allocation weights of the plurality of message channels. Such a message allocation policy may ensure that the total cost sent by using the message satisfies the message allocation objective, which helps reduce the cost of message transmission.

A specific manner of determining the verification pass rate of the message channel is described below with reference to FIG. 2C. FIG. 2C illustrates a schematic diagram of an example process 200C of determining a verification pass rate according to some embodiments of the present disclosure. The message allocation system 110, for example, may determine verification pass rate(s) for any or some of the plurality of message channels based on the example process 200C. That is, for each message channel of the one or more message channels, the verification pass rate may be determined by the process 200C. It may be appreciated that the message allocation system 110 may determine verification pass rates for at least some of the plurality of message channels through the process 200C each time. The following describes example descriptions only by using an example in which the verification pass rate of one message channel is determined as an example, and the one message channel that is currently to be determined as the verification pass rate is referred to as a current message channel.

At block 210, the message allocation system 110 obtains a first number of verification code messages sent via the current message channel within a first time range. The first time range may be any suitable time range, which may be set to 6H only as an example.

At block 220, the message allocation system 110 determines whether the first number reaches a threshold transmission number. The threshold transmission number may be a value preset by the user, or may be a value determined by the message allocation system 110. For example only, the threshold transmission number may be a value determined by the message allocation system 110 based on historical message transmission conditions. For example only, the threshold transmission number may be 100. If the first number reaches the threshold transmission number, the message allocation system 110 may perform the step shown in block 232, and if the first number does not reach the threshold transmission number, the message allocation system 110 may perform the steps shown in block 242.

At block 232, the message allocation system 110 may obtain a second number of verification code messages determined to be passed among the first number of verification code messages. It may be appreciated that, if the transmission of the verification code message is abnormal, the message receiving of the client device of the user is abnormal or the verification code input by the user is wrong, the verification code input by the user may be verified as not passing. It would be noted that, although the message allocation system 110 in the example 200C first determines whether the first number reaches the threshold transmission number and the second number is obtained, in practice, the message allocation system 110 may first obtain the second number (for example, synchronously obtains the first number and the second number at block 210), and then determine whether the first number reaches the threshold transmission number. At block 234, the message allocation system 110 may determine a verification pass rate of the current message channel based on a ratio of the second number to the first number. Taking the example where a number A of verification code messages were sent through the current message channel within the past 6H, and among them, a number a of verification code messages have been determined to be passed, the verification pass rate of the current message channel may be determined as a/A.

At block 242, the message allocation system 110 obtains a third number of verification code messages sent by the current message channel in a second time range, and a fourth number of verification code messages determined to be passed in the third number of verification code messages, the second time range being greater than the first time range. For example only, the second time range may be 3 days. At block 244, the message allocation system 110 may determine a verification pass rate for the current message channel based on a ratio of the fourth number to the third number. Taking the case where the current message channel has sent a number B of verification code messages within the past 3 days, and among them, a number b of verification code messages have been determined to be passed, the verification pass rate of the current message channel may be determined as b/B.

It may be appreciated that, since the first number of the verification code messages sent by the plurality of message channels in the first time range may vary, it is possible that for some of the plurality of message channels, the corresponding first number reaches the threshold transmission number, while for another part of the message channels, the corresponding first number does not reach the threshold transmission number. In this case for the part of the message channels whose corresponding first number reaches the threshold transmission number, the corresponding verification pass rate may be determined based on a ratio of the respective corresponding second number to the first number. For the other part of the message channels whose corresponding first number does not reach the threshold transmission number, the corresponding verification pass rate may be determined based on a ratio of the respective corresponding fourth number to the third number.

In this way, when the number of the verification code messages sent by the current message channel in the first time range satisfies the requirement, the message allocation system 110 may directly determine the verification pass rate of the current message channel based on the verification code messages sent in the first time range, and if the number does not satisfy the requirement, the message allocation system 110 may determine the verification pass rate based on the verification code messages sent by the current message channel in the longer second time range, which helps to ensure that the number of the samples used to determine the verification pass rate is large enough to help improve the accuracy of the determined verification pass rate.

In some embodiments, for each message channel or a part of the message channels among the plurality of message channels, the message allocation system 110 may also determine the verification pass rate of the current message channel directly based on the ratio of the second number determined over the first time range to the first number. That is, in this case, the message allocation system 110 may not need to compare the first number within the first time range to the threshold transmission number. Regardless of the first number, the verification pass rate of the current message channel may be determined based on the ratio of the second number to the first number. This may help reduce the amount of computation of the message allocation system and improve the efficiency of calculating the verification pass rate.

As mentioned above, the message allocation system 110 may determine the respective message allocation weights of the plurality of message channels in real time, or may periodically determine the respective message allocation weights of the plurality of message channels. Taking each period including the duration A as an example, the message allocation system 110 may determine respective message allocation weights of the plurality of message channels at a start moment of the period, and re-determine the respective message allocation weights of the plurality of message channels at a start moment (namely, after the instant long A) of the next period. The specific manner of determining the message allocation weights is described below with reference to FIG. 2D. FIG. 2D illustrates a schematic diagram of an example process 200D of determining a message allocation weight according to some embodiments of the present disclosure.

At block 250, the message allocation system 110 may receive a message request corresponding to the verification code message. The message request may be a message request sent by a client device requesting the verification code to the message allocation system 110, and the message allocation system 110 may send the verification code message to the corresponding client device based on the message request.

At block 260, the message allocation system 110 may determine whether the moment at which the message request is received is within a specified time range. The specified time range is also a period corresponding to the currently determined message allocation weight. For example, if the message allocation system 110 determines the message allocation weight once every 1 hours, and the current message allocation weight is determined by the message allocation system 110 in the Ith hour, the message allocation system 110 may determine whether the moment at which the message request is received is at the Ith hour.

The message allocation system 110 may perform the steps corresponding to block 270 in response to determining that the moment at which the message request is received is within a specified time range (i.e., within the Ith hour). At block 270, the message allocation system 110 may allocate verification code messages to the plurality of message channels based on the message allocation weight corresponding to the specified time range (i.e., the message allocation weight determined at the beginning of the Ith hour).

The message allocation system 110 may perform the steps corresponding to block 280 in response to determining that the moment at which the message request is received is not within a specified time range (e.g., at hour I+1). At block 280, the message allocation system 110 may determine a message allocation weight corresponding to a time range at which the moment the message request is received. That is, the message allocation system 110 may re-determine, in response to the moment when the message request is received falling within the next period, respective message allocation weights of the plurality of message channels.

Therefore, after the message allocation weights are calculated at this time, within the preset period (before the next calculation of the message allocation weights), the message allocation system 110 performs message transmission based on the message allocation weight calculated this time. This can reduce the computational load of determining the message allocation weights and improve the message allocation efficiency.

In summary, according to the embodiments of the present disclosure, the respective message allocation weights of the plurality of message channels are determined based on the respective verification pass rates of the plurality of message channels, the respective unit costs of the message transmissions of the plurality of message channels, and the message allocation objective associated with the total cost of the message transmissions, and the verification code messages are allocated to the plurality of message channels based on the respective message allocation weights of the plurality of message channels. Such a message allocation policy may ensure that the total cost sent by using the message satisfies the message allocation objective, which helps reduce the cost of message transmission.

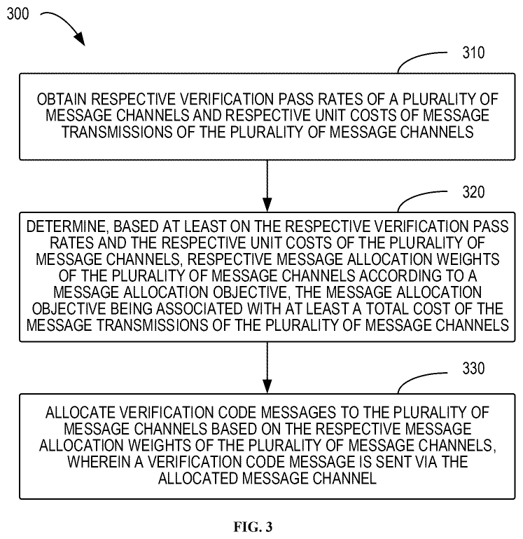

FIG. 3 illustrates a flowchart of a method 300 for message allocation according to some embodiments of the present disclosure. The method 300 may be implemented at the message allocation system 110. The method 300 is described below with reference to FIG. 1.

At block 310, the message allocation system 110 obtains respective verification pass rates of a plurality of message channels and respective unit costs of message transmissions of the plurality of message channels.

At block 320, the message allocation system 110 determines, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels.

At block 330, the message allocation system 110 allocates verification code messages to the plurality of message channels based on the respective message allocation weights of the plurality of message channels, wherein a verification code message is sent via the allocated message channel.

In some embodiments, determining the respective message allocation weights of the plurality of message channels includes: determining, in response to at least one constraint condition being satisfied, the respective message allocation weights of the plurality of message channels according to the message allocation objective, wherein the at least one constraint condition is determined based on at least one of the following: the respective verification pass rates of the plurality of message channels, or the respective unit costs of the plurality of message channels.

In some embodiments, determining the respective message allocation weights of the plurality of message channels includes: determining, in response to at least one constraint condition being satisfied, the respective message allocation weights of the plurality of message channels according to the message allocation objective, wherein the at least one constraint condition includes at least one of the following: a first constraint condition indicating that a message allocation weight of a message channel is within a specified range; a second constraint condition indicating that a total message allocation weight of the plurality of message channels satisfies a predetermined value; a third constraint condition indicating that an average verification pass rate of the plurality of message channels reaches a threshold verification pass rate; or a fourth constraint condition indicating that the total cost of the message transmissions of the plurality of message channels is lower than a threshold cost.

In some embodiments, obtaining the respective verification pass rates of the plurality of message channels includes: for a first message channel of the plurality of message channels, obtaining a first number of verification code messages sent via the first message channel within a first time range, and a second number of verification code messages determined to be passed among the first number of verification code messages; and determining a verification pass rate of the first message channel based on a ratio of the second number to the first number.

In some embodiments, obtaining the respective verification pass rates of the plurality of message channels includes: for a second message channel of the plurality of message channels, obtaining a first number of verification code messages sent via the second message channel within a first time range; obtaining, in response to the first number reaching a threshold transmission number, a second number of verification code messages determined to be passed in the first number of verification code messages; and determining a verification pass rate of the second message channel based on a ratio of the second number to the first number.

In some embodiments, obtaining the respective verification pass rates of the plurality of message channels further includes: obtaining, in response to the first number not reaching the threshold transmission number, a third number of verification code messages sent via the second message channel within a second time range, and a fourth number of verification code messages determined to be passed in the third number of verification code messages, the second time range being greater than the first time range; and determining the verification pass rate of the second message channel based on a ratio of the fourth number to the third number.

In some embodiments, the message allocation objective is configured to at least one of the following: minimize or decrease the total cost of the message transmissions of the plurality of message channels to satisfy a first target value, or maximize or increase a ratio of an average verification pass rate of the message transmissions of the plurality of message channels to the total cost to satisfy a second target value, wherein the total cost of the message transmissions of the plurality of message channels is determined based on the respective message allocation weights and the respective unit costs of the plurality of message channels, and wherein the average verification pass rate is determined based on the respective message allocation weights and the respective verification pass rates of the plurality of message channels.

In some embodiments, the message allocation objective is represented as an objective function associated with at least the respective message allocation weights of the plurality of message channels, and wherein determining the respective message allocation weights of the plurality of message channels based on the message allocation objective includes: determining, based on at least the respective verification pass rates and the respective unit costs of the plurality of message channels, the respective message allocation weights of the plurality of message channels by solving the objective function with a convex optimization algorithm

In some embodiments, the respective message allocation weights of the plurality of message channels is valid for a period of time, and wherein allocating verification code messages to the plurality of message channels includes: allocating, in response to receiving transmission requests for the verification code messages within the period of time, the verification code messages to the plurality of message channels based on the message allocation weights valid for the period of time.

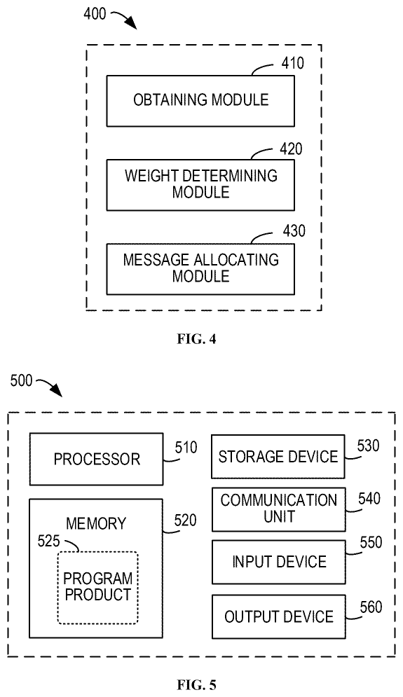

Embodiments of the present disclosure also provide a corresponding apparatus for implementing the above method or process. FIG. 4 is a schematic structural block diagram of an apparatus 400 for message allocation according to some embodiments of the present disclosure. The apparatus 400 may be implemented, for example, in or included in the message allocation system 110. The various modules/components in the apparatus 400 may be implemented by hardware, software, firmware, or any combination thereof.

As shown in the figure, the apparatus 400 includes an obtaining module 410, configured to obtain respective verification pass rates of a plurality of message channels and respective unit costs of message transmissions of the plurality of message channels. The apparatus 400 further includes a weight determining module 420 configured to determine, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels. The apparatus 400 further includes a message allocating module 430 configured to allocate verification code messages to the plurality of message channels based on the respective message allocation weights of the plurality of message channels, wherein a verification code message is sent via the allocated message channel.

In some embodiments, the weight determining module 420 is further configured to, determine, in response to at least one constraint condition being satisfied, the respective message allocation weights of the plurality of message channels according to the message allocation objective, wherein the at least one constraint condition is determined based on at least one of the following: the respective verification pass rates of the plurality of message channels, or the respective unit costs of the plurality of message channels.

In some embodiments, the weight determining module 420 is further configured to, determine, in response to at least one constraint condition being satisfied, the respective message allocation weights of the plurality of message channels according to the message allocation objective, wherein the at least one constraint condition includes at least one of the following: a first constraint condition indicating that a message allocation weight of a message channel is within a specified range; a second constraint condition indicating that a total message allocation weight of the plurality of message channels satisfies a predetermined value; a third constraint condition indicating that an average verification pass rate of the plurality of message channels reaches a threshold verification pass rate; or a fourth constraint condition indicating that the total cost of the message transmissions of the plurality of message channels is lower than a threshold cost.

In some embodiments, the obtaining module 410 is further configured to: for a first message channel of the plurality of message channels, obtain a first number of verification code messages sent via the first message channel within a first time range, and a second number of verification code messages determined to be passed among the first number of verification code messages; and determine a verification pass rate of the first message channel based on a ratio of the second number to the first number.

In some embodiments, the obtaining module 410 is further configured to: for a second message channel of the plurality of message channels, obtain a first number of verification code messages sent via the second message channel within a first time range; obtain, in response to the first number reaching a threshold transmission number, a second number of verification code messages determined to be passed in the first number of verification code messages; and determine a verification pass rate of the second message channel based on a ratio of the second number to the first number.

In some embodiments, the obtaining module 410 is further configured to: obtain, in response to the first number not reaching the threshold transmission number, a third number of verification code messages sent via the second message channel within a second time range, and a fourth number of verification code messages determined to be passed in the third number of verification code messages, the second time range being greater than the first time range; and determine the verification pass rate of the second message channel based on a ratio of the fourth number to the third number.

In some embodiments, the message allocation objective is configured to at least one of the following: minimize or decrease the total cost of the message transmissions of the plurality of message channels to satisfy a first target value, or maximize or increase a ratio of an average verification pass rate of the message transmissions of the plurality of message channels to the total cost to satisfy a second target value, wherein the total cost of the message transmissions of the plurality of message channels is determined based on the respective message allocation weights and the respective unit costs of the plurality of message channels, and wherein the average verification pass rate is determined based on the respective message allocation weights and the respective verification pass rates of the plurality of message channels.

In some embodiments, the message allocation objective is represented as an objective function associated with at least the respective message allocation weights of the plurality of message channels, and the weight determining module 420 is further configured to: determine, based on at least the respective verification pass rates and the respective unit costs of the plurality of message channels, the respective message allocation weights of the plurality of message channels by solving the objective function with a convex optimization algorithm.

In some embodiments, the respective message allocation weights of the plurality of message channels is valid for a period of time, and the message allocating module 430 is further configured to allocate, in response to receiving transmission requests for the verification code messages within the period of time, the verification code messages to the plurality of message channels based on the message allocation weights valid for the period of time.

The units and/or modules included in the apparatus 400 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 400 may be implemented, at least in part, by one or more hardware logic components. By way of example and not limitation, example types of hardware logic components that may be used include Field Programmable Gate Arrays (FPGAs), Application Specific Integrated Circuits (ASICs), Application Specific Standard Products (ASSPs), System on Chips (SOCs), Complex Programmable Logic Devices (CPLDs), and the like.

It would be appreciated that one or more of the above methods could be performed by a suitable electronic device or a combination of electronic devices. Such electronic devices or combinations of electronic devices may be implemented, for example, as the message allocation system 110 and/or the client device 120 in FIG. 1.

FIG. 5 illustrates a block diagram of an electronic device 500 in which one or more embodiments of the present disclosure may be implemented. It would be appreciated that the electronic device 500 illustrated in FIG. 5 is merely example and would not constitute any limitation on the functionality and scope of the embodiments described herein. The electronic device 500 shown in FIG. 5 may include or be implemented as the message allocation system 110 of FIG. 1, or the apparatus 400 of FIG. 4.

As shown in FIG. 5, the electronic device 500 is in a form of a general-purpose electronic device. Components of the electronic device 500 may include, but are not limited to, one or more processors or processing units 510, memory 520, storage device 530, one or more communication units 540, one or more input devices 550, and one or more output devices 560. The processing unit 510 may be an actual or virtual processor and is capable of performing various processes based on programs stored in the memory 520. In a multiprocessor system, a plurality of processing units perform computer-executable instructions in parallel to improve the parallel processing capability of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a disk, or any other medium that may be capable of storing information and/or data and may be accessible within the electronic device 500.

The electronic device 500 may further include additional removable/non-removable, volatile/non-volatile storage media. Although not shown in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 520 may include a computer program product 525 having one or more program modules that are configured to perform various methods or actions of various embodiments of the present disclosure.

The communication unit 540 implements communication with other electronic devices via a communication medium. Additionally, the functions of the components of the electronic device 500 may be implemented as a single computing cluster or a plurality of computing machines that are capable of communicating over a communication connection. Thus, the electronic device 500 may use logical connections to one or more other servers, networked personal computers (PCs), or a further network node to operate in a networked environment.

The input device 550 may be one or more input devices, such as a mouse, a keyboard, a tracking ball, and the like. The output device 560 may be one or more output devices, such as a monitor, a speaker, a printer, and the like. The electronic device 500 may also communicate, as desired, via the communication unit 540, with one or more external devices (not shown), external devices such as storage devices, display devices, etc., with one or more devices that enable a user to interact with the electronic device 500, or with any device that enables the electronic device 500 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some updated implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for message allocation, comprising:
obtaining respective verification pass rates of a plurality of message channels and respective unit costs of message transmissions of the plurality of message channels;
determining, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and
allocating verification code messages to the plurality of message channels based on the respective message allocation weights of the plurality of message channels, wherein a verification code message is sent via an allocated message channel.

2. The method of claim 1, wherein determining the respective message allocation weights of the plurality of message channels comprises:
determining, in response to at least one constraint condition being satisfied, the respective message allocation weights of the plurality of message channels according to the message allocation objective, wherein the at least one constraint condition is determined based on at least one of the following:
the respective verification pass rates of the plurality of message channels, or
the respective unit costs of the plurality of message channels.

3. The method of claim 1, wherein determining the respective message allocation weights of the plurality of message channels comprises:
determining, in response to at least one constraint condition being satisfied, the respective message allocation weights of the plurality of message channels according to the message allocation objective, wherein the at least one constraint condition comprises at least one of the following:
a first constraint condition indicating that a message allocation weight of a message channel is within a specified range;
a second constraint condition indicating that a total message allocation weight of the plurality of message channels satisfies a predetermined value;
a third constraint condition indicating that an average verification pass rate of the plurality of message channels reaches a threshold verification pass rate; or
a fourth constraint condition indicating that the total cost of the message transmissions of the plurality of message channels is lower than a threshold cost.

4. The method of claim 1, wherein obtaining the respective verification pass rates of the plurality of message channels comprises: for a first message channel of the plurality of message channels,
obtaining a first number of verification code messages sent via the first message channel within a first time range, and a second number of verification code messages determined to be passed among the first number of verification code messages; and
determining a verification pass rate of the first message channel based on a ratio of the second number to the first number.

5. The method of claim 1, wherein obtaining the respective verification pass rates of the plurality of message channels comprises: for a second message channel of the plurality of message channels,
obtaining a first number of verification code messages sent via the second message channel within a first time range;
obtaining, in response to the first number reaching a threshold transmission number, a second number of verification code messages determined to be passed in the first number of verification code messages; and
determining a verification pass rate of the second message channel based on a ratio of the second number to the first number.

6. The method of claim 5, wherein obtaining the respective verification pass rates of the plurality of message channels further comprises:
obtaining, in response to the first number not reaching the threshold transmission number, a third number of verification code messages sent via the second message channel within a second time range, and a fourth number of verification code messages determined to be passed in the third number of verification code messages, the second time range being greater than the first time range; and
determining the verification pass rate of the second message channel based on a ratio of the fourth number to the third number.

7. The method of claim 1, wherein the message allocation objective is configured to at least one of the following:
minimize or decrease the total cost of the message transmissions of the plurality of message channels to satisfy a first target value, or
maximize or increase a ratio of an average verification pass rate of the message transmissions of the plurality of message channels to the total cost to satisfy a second target value,
wherein the total cost of the message transmissions of the plurality of message channels is determined based on the respective message allocation weights and the respective unit costs of the plurality of message channels, and wherein the average verification pass rate is determined based on the respective message allocation weights and the respective verification pass rates of the plurality of message channels.

8. The method of claim 1, wherein the message allocation objective is represented as an objective function associated with at least the respective message allocation weights of the plurality of message channels, and wherein determining the respective message allocation weights of the plurality of message channels based on the message allocation objective comprises:
determining, based on at least the respective verification pass rates and the respective unit costs of the plurality of message channels, the respective message allocation weights of the plurality of message channels by solving the objective function with a convex optimization algorithm.

9. The method of claim 1, wherein the respective message allocation weights of the plurality of message channels is valid for a period of time, and wherein allocating verification code messages to the plurality of message channels comprises:
allocating, in response to receiving transmission requests for the verification code messages within the period of time, the verification code messages to the plurality of message channels based on the respective message allocation weights valid for the period of time.

10. An electronic device, comprising:
at least one processor; and
at least one memory coupled to the at least one processor and storing instructions for execution by the at least one processor, the instructions, when executed by the at least one processor, causing the electronic device to perform operations comprising:
obtaining respective verification pass rates of a plurality of message channels and respective unit costs of message transmissions of the plurality of message channels;
determining, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and
allocating verification code messages to the plurality of message channels based on the respective message allocation weights of the plurality of message channels, wherein a verification code message is sent via an allocated message channel.

11. The electronic device of claim 10, wherein determining the respective message allocation weights of the plurality of message channels comprises:
determining, in response to at least one constraint condition being satisfied, the respective message allocation weights of the plurality of message channels according to the message allocation objective, wherein the at least one constraint condition is determined based on at least one of the following:
the respective verification pass rates of the plurality of message channels, or
the respective unit costs of the plurality of message channels.

12. The electronic device of claim 10, wherein determining the respective message allocation weights of the plurality of message channels comprises:
determining, in response to at least one constraint condition being satisfied, the respective message allocation weights of the plurality of message channels according to the message allocation objective, wherein the at least one constraint condition comprises at least one of the following:
a first constraint condition indicating that a message allocation weight of a message channel is within a specified range;
a second constraint condition indicating that a total message allocation weight of the plurality of message channels satisfies a predetermined value;
a third constraint condition indicating that an average verification pass rate of the plurality of message channels reaches a threshold verification pass rate; or
a fourth constraint condition indicating that the total cost of the message transmissions of the plurality of message channels is lower than a threshold cost.

13. The electronic device of claim 10, wherein obtaining the respective verification pass rates of the plurality of message channels comprises: for a first message channel of the plurality of message channels,
obtaining a first number of verification code messages sent via the first message channel within a first time range, and a second number of verification code messages determined to be passed among the first number of verification code messages; and
determining a verification pass rate of the first message channel based on a ratio of the second number to the first number.

14. The electronic device of claim 10, wherein obtaining the respective verification pass rates of the plurality of message channels comprises: for a second message channel of the plurality of message channels,
obtaining a first number of verification code messages sent via the second message channel within a first time range;
obtaining, in response to the first number reaching a threshold transmission number, a second number of verification code messages determined to be passed in the first number of verification code messages; and
determining a verification pass rate of the second message channel based on a ratio of the second number to the first number.

15. The electronic device of claim 14, wherein obtaining the respective verification pass rates of the plurality of message channels further comprises:
obtaining, in response to the first number not reaching the threshold transmission number, a third number of verification code messages sent via the second message channel within a second time range, and a fourth number of verification code messages determined to be passed in the third number of verification code messages, the second time range being greater than the first time range; and
determining the verification pass rate of the second message channel based on a ratio of the fourth number to the third number.

16. The electronic device of claim 10, wherein the message allocation objective is configured to at least one of the following:
minimize or decrease the total cost of the message transmissions of the plurality of message channels to satisfy a first target value, or
maximize or increase a ratio of an average verification pass rate of the message transmissions of the plurality of message channels to the total cost to satisfy a second target value,
wherein the total cost of the message transmissions of the plurality of message channels is determined based on the respective message allocation weights and the respective unit costs of the plurality of message channels, and wherein the average verification pass rate is determined based on the respective message allocation weights and the respective verification pass rates of the plurality of message channels.

17. The electronic device of claim 10, wherein the message allocation objective is represented as an objective function associated with at least the respective message allocation weights of the plurality of message channels, and wherein determining the respective message allocation weights of the plurality of message channels based on the message allocation objective comprises:
determining, based on at least the respective verification pass rates and the respective unit costs of the plurality of message channels, the respective message allocation weights of the plurality of message channels by solving the objective function with a convex optimization algorithm.

18. The electronic device of claim 10, wherein the respective message allocation weights of the plurality of message channels is valid for a period of time, and wherein allocating verification code messages to the plurality of message channels comprises:
allocating, in response to receiving transmission requests for the verification code messages within the period of time, the verification code messages to the plurality of message channels based on the respective message allocation weights valid for the period of time.

19. A non-transitory computer-readable storage medium having computer-executable instructions stored thereon, the computer-executable instructions being executable by at least one processor to perform operations comprising:
obtaining respective verification pass rates of a plurality of message channels and respective unit costs of message transmissions of the plurality of message channels;
determining, based at least on the respective verification pass rates and the respective unit costs of the plurality of message channels, respective message allocation weights of the plurality of message channels according to a message allocation objective, the message allocation objective being associated with at least a total cost of the message transmissions of the plurality of message channels; and
allocating verification code messages to the plurality of message channels based on the respective message allocation weights of the plurality of message channels, wherein a verification code message is sent via an allocated message channel.

20. The non-transitory computer-readable storage medium of claim 19, wherein determining the respective message allocation weights of the plurality of message channels comprises:
determining, in response to at least one constraint condition being satisfied, the respective message allocation weights of the plurality of message channels according to the message allocation objective, wherein the at least one constraint condition is determined based on at least one of the following:
the respective verification pass rates of the plurality of message channels, or
the respective unit costs of the plurality of message channels.
